(19) United States
(12) Patent Application Publication
(10) Pub. No.: US 2024/0074449 A1
(43) Pub. Date: Mar. 7, 2024

(54) BOTANICAL COFFEE MIXTURE ASSEMBLY

(71) Applicant: Sharon Dudley, Bemidji, MN (US)

(72) Inventor: Sharon Dudley, Bemidji, MN (US)

(21) Appl. No.: 17/902,489

(22) Filed: Sep. 2, 2022

(51) Int. Cl. A23F 5/14; B65D 1/02

(52) U.S. Cl. CPC A23F 5/14; B65D 1/023; B65D 2203/12

(57) ABSTRACT

A botanical coffee mixture assembly for producing a calming coffee drink includes a mixture consumed prior to sleep. The mixture includes a plurality of decaffeinated coffee bean grounds and a plurality of melatonin herb grounds. A container stores the mixture. The container has an exterior surface and an interior surface. The interior surface of the container faces a chamber. The container has a top end and a bottom end. The top end has a neck extends upward towards an opening. A lid is positioned upon the opening of the container. A decoration is positioned on the exterior surface of the container. The decoration includes a logo, a slogan, and a plurality of stars and a moon resembling a night sky imagery.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to somnolent herbal device and more particularly pertains to a new somnolent herbal device for producing a calming coffee drink.

### (2) Description of Related Art Including Information Disclosed Under 37 CFR 1.97 and 1.98

The prior art relates to somnolent herbal devices. The prior art includes a variety of somnolent herbal devices comprising a melatonin herb mixture. Known prior art lacks a somnolent herbal device comprising a melatonin herb and decaffeinated coffee mixture stored within a custom container being configured for consuming prior to sleep.

### BRIEF SUMMARY OF THE INVENTION

An embodiment of the disclosure meets the needs presented above by generally comprising a mixture. The mixture is configured for being consumed prior to sleep. The mixture includes a plurality of decaffeinated coffee bean grounds and a plurality of melatonin herb grounds. A container is configured for storing the mixture. The container has an exterior surface and an interior surface wherein the interior surface of the container faces a chamber. The container has a top end and a bottom end. The top end has a neck protruding upward from the top end towards an opening. A lid is positioned upon the opening of the container and is configured for enclosing the chamber of the container. A decoration is positioned on the exterior surface of the container further includes a logo being configured for showing a product name of the mixture and a description of the mixture. In addition, the decoration includes a slogan being configured for showing a phrase used to advertise the mixture. Furthermore, the decoration includes a plurality of stars and a moon being configured to resemble a night sky imagery.

Furthermore, a method for inducing a somnolent effect on the user with a botanical coffee mixture assembly includes the step of combining a plurality of decaffeinated coffee bean grounds with a plurality of melatonin herb grounds to produce a mixture. The user stores the mixture within a chamber of a container. Subsequently, the user adds the mixture to a coffee producing device. The coffee producing device is configured for being a variety of coffee makers wherein the mixture is configured for steeping within hot water to produce a coffee drink. The user consumes the coffee drink prior to sleep such that the coffee drink is configured for inducing a somnolent effect on the user wherein facilitating in sleep.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a front view of a botanical coffee mixture assembly according to an embodiment of the disclosure.

FIG. 2 is a rear isometric view of an embodiment of the disclosure.

FIG. 3 is a block diagram view of an embodiment of the disclosure.

FIG. 4 is an in-use view of an embodiment of the disclosure.

### DETAILED DESCRIPTION OF THE INVENTION

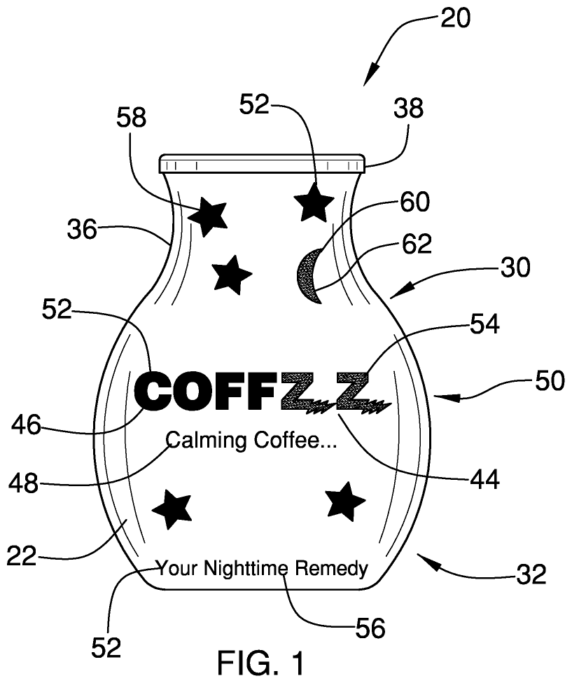

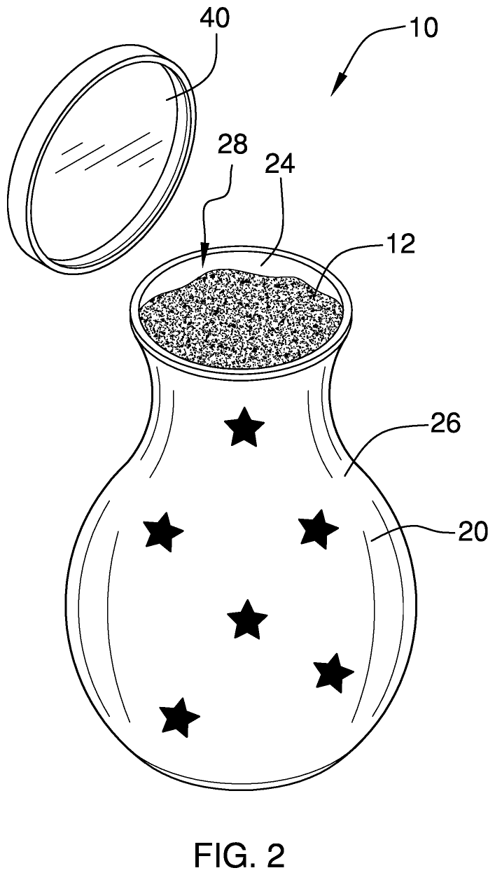

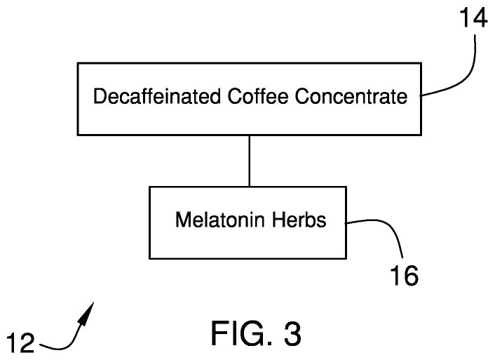

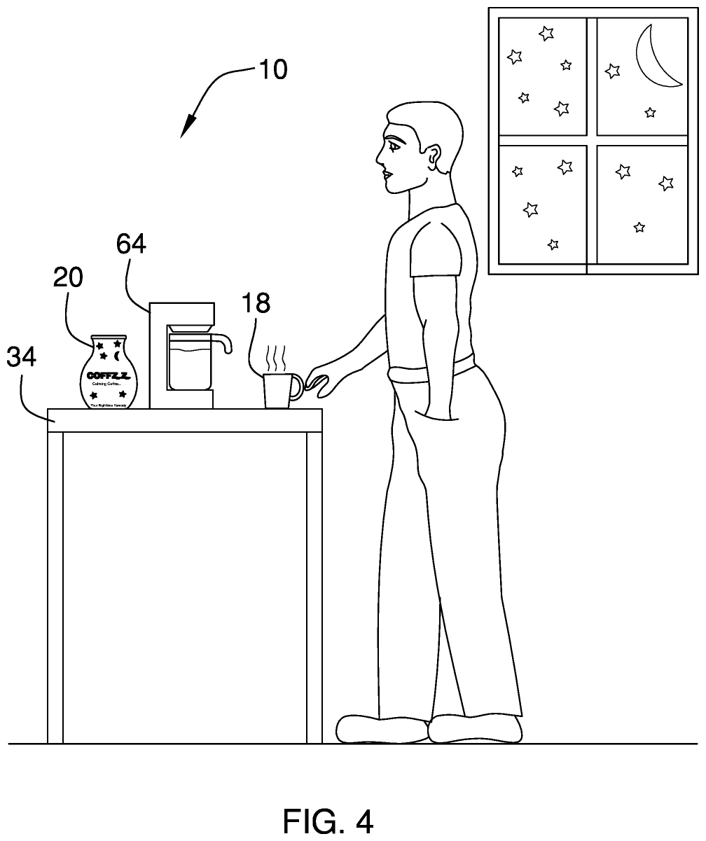

With reference now to the drawings, and in particular to FIGS. 1 through 4 thereof, a new somnolent herbal device embodying the principles and concepts of an embodiment of the disclosure and generally designated by the reference numeral 10 will be described.

As best illustrated in FIGS. 1 through 4, the botanical coffee mixture assembly generally comprises a mixture 12. The mixture 12 is configured for being consumed prior to sleep. The mixture 12 includes a plurality of decaffeinated coffee bean grounds 14 and a plurality of melatonin herb grounds 16. The mixture 12 is broken down into a fine powder used for producing coffee. The mixture 12 is configured for being steeped within hot water to produce a coffee drink 18. The coffee drink 18 creates a calming and drowsy effect to facilitating with sleep.

A container 20 is configured for storing the mixture 12. The container 12 has a spherical shaped body including an exterior surface 22 and an interior surface 24. The exterior surface 22 is configured for being a darkened blue color 26. The interior surface 24 of the container 20 faces a chamber 28 defining a space for holding the mixture 12. The container 20 has a top end 30 and a bottom end 32. The bottom end 32 is flat and is configured for supporting the container 20 upon a surface 34. The top end 30 has a neck 36 protruding upward from the top end 30 towards an opening 38. The opening 38 is circular and is an aperture to the chamber 28 of the container 20. A lid 40 is positioned upon the opening 38 of the container 20. The lid 40 is circular and is removable from the opening 38 of the container 20. The lid 40 is configured for enclosing the chamber 28 of the container 20 with the mixture 12 inside.

A decoration 42 is positioned on the exterior surface 22 of the container 20. The decoration 42 is configured for providing a visual appeal to the container 20 of the mixture 12. The decoration 42 further includes a logo 44. The logo 44 is configured for showing a product name 46 of the mixture 12 and a description 48 of the mixture 12. The logo 44 is positioned in a center 50 from the bottom end 32 to the top end 30 of the container 20. The product name 46 of the logo 44 includes the letters COFFZZ. The letters COFF of the logo 44 are configured for being a white color 52, whereas the letters ZZ of the logo are configured for being a red color 54. The description 48 is configured for being the white color 52. A slogan 56 of the decoration 42 is configured for showing a phrase used to advertise the mixture 12. The slogan 56 is positioned proximate to the bottom end 32 of the container 20. The slogan 56 is configured for being the white color 52. Furthermore, the decoration 42 includes a plurality of stars 58 and a moon 60. The plurality of stars 58 and the moon 60 are configured to resemble a night sky imagery upon the darkened blue color 26 of the exterior surface 22 of the container 20. Each of the stars 58 is configured for being the white color 52, and the moon 60 is configured for being a yellow color 62.

In use, the plurality of decaffeinated coffee bean grounds 14 is combined with the plurality of melatonin herb grounds 16 to produce the mixture 12. The user stores the mixture 12 within the chamber 26 of the container 20. Subsequently, the user adds the mixture 12 to a coffee producing device 64. The coffee producing device 64 is configured for being a variety of coffee makers such as a coffee machine or an espresso machine. The mixture 12 is configured for steeping within hot water to produce the coffee drink 18. The user consumes the coffee drink 18 prior to sleep. The plurality of melatonin herb grounds 16 of the mixture 12 of the coffee drink 18 is configured for inducing a somnolent effect on the user wherein facilitating in sleep.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A botanical coffee mixture assembly configured for inducing a somnolent effect on the user, the botanical coffee mixture assembly comprising:
a mixture being configured for being consumed prior to sleep, the mixture including a plurality of decaffeinated coffee bean grounds and a plurality of melatonin herb grounds;
a container being configured for storing the mixture, the container having an exterior surface and an interior surface, the interior surface of the container facing a chamber, the container having a top end and a bottom end, the top end having a neck, the neck protruding upward from the top end towards an opening;
a lid being positioned upon the opening of the container, the lid being configured for enclosing the chamber of the container;
a decoration being positioned on the exterior surface of the container, the decoration further including:
a logo being configured for showing a product name of the mixture and a description of the mixture;
a slogan being configured for showing a phrase used to advertise the mixture; and
a plurality of stars and a moon being configured to resemble a night sky imagery.

2. The botanical coffee mixture assembly of claim 1, further comprising the mixture being configured for being steeped within hot water to produce a coffee drink.

3. The botanical coffee mixture assembly of claim 1, further comprising the container having a spherical shaped body.

4. The botanical coffee mixture assembly of claim 1, further comprising the exterior surface being configured for being a darkened blue color.

5. The botanical coffee mixture assembly of claim 1, further comprising the chamber defining a space for holding the mixture.

6. The botanical coffee mixture assembly of claim 1, further comprising the bottom end being flat, the bottom end being configured for supporting the container upon a surface.

7. The botanical coffee mixture assembly of claim 1, further comprising the opening being circular, the opening being an aperture to the chamber of the container.

8. The botanical coffee mixture assembly of claim 1, further comprising the lid being circular, the lid being removable from the opening of the container.

9. The botanical coffee mixture assembly of claim 1, further the decoration being configured for providing a visual appeal to the container of the mixture.

10. The botanical coffee mixture assembly of claim 1, further comprising the logo being positioned in a center from the bottom end to the top end of the container.

11. The botanical coffee mixture assembly of claim 1, further comprising the product name of the logo including the letters COFFZZ, the letters COFF of the logo being configured for being a white color, the letters ZZ of the logo being configured for being a red color, the description being configured for being a white color

12. The botanical coffee mixture assembly of claim 1, further comprising the slogan being positioned proximate to the bottom end of the container, the slogan being configured for being the white color.

13. The botanical coffee mixture assembly of claim 1, further comprising each of the stars being configured for being the white color, the moon being configured for being a yellow color.

14. A botanical coffee mixture assembly configured for inducing a somnolent effect on the user, the botanical coffee mixture assembly comprising:
a mixture being configured for being consumed prior to sleep, the mixture including a plurality of decaffeinated coffee bean grounds and a plurality of melatonin herb grounds, the mixture being configured for being steeped within hot water to produce a coffee drink;
a container being configured for storing the mixture, the container having a spherical shaped body, the container having an exterior surface and an interior surface, the exterior surface being configured for being a darkened blue color, the interior surface of the container facing a chamber, the chamber defining a space for holding the mixture, the container having a top end and a bottom end, the bottom end being flat, the bottom end being configured for supporting the container upon a surface, the top end having a neck, the neck protruding upward from the top end towards an opening, the opening being circular, the opening being an aperture to the chamber of the container;
a lid being positioned upon the opening of the container, the lid being circular, the lid being removable from the opening of the container, the lid being configured for enclosing the chamber of the container;
a decoration being positioned on the exterior surface of the container, the decoration being configured for providing a visual appeal to the container of the mixture, the decoration further including:
a logo being configured for showing a product name of the mixture and a description of the mixture, the logo being positioned in a center from the bottom end to the top end of the container, the product name of the logo including the letters COFFZZ, the letters COFF of the logo being configured for being a white color, the letters ZZ of the logo being configured for being a red color, the description being configured for being a white color;
a slogan being configured for showing a phrase used to advertise the mixture, the slogan being positioned proximate to the bottom end of the container, the slogan being configured for being the white color; and
a plurality of stars and a moon being configured to resemble a night sky imagery, each of the stars being configured for being the white color, the moon being configured for being a yellow color.

15. A method for inducing a somnolent effect on the user with a botanical coffee mixture assembly, the method including the step of:
combining a plurality of decaffeinated coffee bean grounds with a plurality of melatonin herb grounds to produce a mixture, storing the mixture within a chamber of a container;
adding the mixture to a coffee producing device, the coffee producing device being configured for being a variety of coffee makers, the mixture being configured for steeping within hot water to produce a coffee drink; and
consuming the coffee drink prior to sleep, the coffee drink being configured for inducing a somnolent effect on the user wherein facilitating in sleep.
